(19) United States
(12) Patent Application Publication
(10) Pub. No.: US 2014/0147884 A1
(43) Pub. Date: May 29, 2014

(54) LASER MICRODISSECTION DEVICE AND METHOD

(71) Applicant: LEICA MICROSYSTEMS CMS GMBH, (US)

(72) Inventors: Falk Schlaudraff, Butzbach/Nieder-Weisel (DE); Christian Woditschka, Huettenberg (DE)

(73) Assignee: LEICA MICROSYSTEMS CMS GMBH, Wetzlar (DE)

(21) Appl. No.: 13/873,284

(22) Filed: Apr. 30, 2013

(30) Foreign Application Priority Data
May 2, 2012 (DE) 10 2012 207 240.3

(51) Int. Cl. G01N 1/44

(52) U.S. Cl. CPC G01N 1/44
USPC 435/40.52; 422/536

(57) ABSTRACT

A laser microdissection device includes a microscope stage for carrying a specimen to be cut, a laser light source for generating a laser beam and a microscope objective for focusing the laser beam onto the specimen. An optical laser scanning device is configured to deflect the laser beam so as to move the laser beam focus in an X-Y direction perpendicular to a main axis of the microscope objective. The laser microdissection device also includes at least one of a Z displacement device configured to move the microscope stage in a Z direction, or an optical focus shifting device configured to move the focus of the laser beam in the Z direction. The Z displacement device and/or optical focus shifting device are controllable, together with the optical laser scanning device, so as to move the laser beam focus in the specimen along a three-dimensional cut line in an X-Y-Z direction.

### CROSS REFERENCE TO RELATED APPLICATIONS

This application claims priority to German Patent Application No. 10 2012 207 240.3, filed May 2, 2012, which is hereby incorporated by reference herein in its entirety.

### FIELD

The present invention relates to a laser microdissection device having a microscope stage, a laser light source, a microscope objective and an optical laser scanning device, and to a corresponding laser microdissection method.

### BACKGROUND

A known laser microdissection device is described in detail in the Applicant's German patent DE 100 18 253 C2. The laser microdissection device therein comprises a microscope stage that carries a specimen to be cut, also an incident-light device, a laser light source, and a microscope objective for focusing the laser light of the laser light source onto the specimen. Human or animal tissue samples, but also plant samples, can be used as a specimen to be cut. In principle, however, artificial fabrics or plastics (PEN, PET, PPS, POL, fluorocarbon), glass, and certain thin metals or stone samples can also be used. UV laser light is usually used, the laser beam usually being pulsed. The high energy density generated at the focus of the laser beam is used to cut (dissect) a selected specimen region out of the remainder of the specimen. When laser pulses are used, a small hole in the specimen is created by absorption of a laser pulse. A cut line is then produced by suitable serial arrangement of such holes. The pulse energy depends on the sample hardness. High pulse frequencies are used for rapid cutting and in order to generate fine cut lines.

With the laser microdissection device known from DE 100 18 253 C2, the microscope stage is arranged in stationary fashion with reference to the X-Y direction (generally the horizontal plane) during cutting. Arranged in the incident-light device is a laser scanning device that is made up of two thick glass wedge plates that are tilted in terms of the optical axis and are rotatable mutually independently around the optical axis. The laser beam is guided through these glass wedge plates, with the result that it is deflected with respect to the optical axis through a deflection angle α. The deflection angle can be adjusted and varied by rotating the wedge plates around the optical axis. The thickness and obliquity of the glass wedge plates is designed in such a way that for all deflection angles α, the center of the objective pupil of the microscope objective is arrived at.

The deflection angle α of the laser beam with respect to the optical axis can be adjusted by rotating the glass wedge plates relative to one another around the optical axis, with the result that the focus of the laser beam can be directed onto any desired points in the X-Y plane of the specimen. For this, the maximum deflection angle α is dimensioned such that that the laser beam is deflected to the edge of the field of view. This is then true simultaneously for all objectives, regardless of their magnification. The laser microdissection device described therein can do without an expensive motorized X-Y stage. Because the microscope stage is stationary during the cutting operation, the user can observe and monitor the cutting operation in the specimen. The glass wedge plates are preferably controlled via stepping motors, which then perform a relative rotation of the glass wedge plates with respect to one another in order to establish a specific deflection angle α at a specific azimuth angle, so that a previously defined cut line in the horizontal plane of the specimen (X-Y direction) can be followed with the focus of the laser beam.

Reference is made expressly to the aforementioned DE 100 18 253 C2 regarding details in terms of the construction and function of the laser microdissection devices described therein, and details of the glass wedge plates used therein. The disclosure in this regard is also explicitly intended to be incorporated in full into the present Application, with no need to repeat details from that document. The present invention proceeds in particular from a laser microdissection device according to DE 100 18 253 C2; the principles of the invention can also be transferred to dissection devices of other types and implemented therein.

A laser microdissection device operating similarly is known from the Applicant's DE 2005 008 925 A1. This device encompasses a microscope having an illumination beam path directed onto the sample and an imaging beam path that images the sample. The microscope furthermore encompasses a fluorescence device having an excitation filter, a dichroic beam splitter, and a blocking filter. The dichroic beam splitter and the blocking filter are spectrally transparent to the laser beam, so that the laser beam can be directed through the blocking filter and the dichroic beam splitter onto the sample. Laser beam guidance can thereby be combined in part with the illumination beam path of the fluorescence device. The fluorescence device, and cutting of the sample by means of the laser beam (microdissection), can be activated simultaneously.

US 2011/0192534 A1 of Molecular Machines & Industries AG describes a method for isolating a layer segment of biological material. Firstly the layer of biological material is placed onto a specimen slide and is covered with a thin (protective) film. A strip having an adhesive layer is applied onto said film. By means of a laser beam focused into the tissue sample, a segment is cut out of the tissue sample, and at the same time a corresponding segment is cut out of the film (which covers the tissue sample and fuses with the tissue sample segment), along a cut line. The cut-out segment can be detached from its surroundings by lifting the adhesive strip. The adhesive strip can be located in the interior of a cover of a dissectate collector. By lifting the cover off the specimen slide, the cut-out tissue specimen segment can thereby also be removed, and it is located in the dissectate collector after the lid is closed. A laser dissection device having an inverted microscope is used for microdissection here. A UV-absorbing PET film or PEN film is used as a (protective) film.

### SUMMARY

In an embodiment, the present invention provides a laser microdissection device including a microscope stage for carrying a specimen to be cut, a laser light source for generating a laser beam and a microscope objective for focusing the laser beam onto the specimen, the microscope objective including a main axis. An optical laser scanning device is configured to deflect the laser beam so as to move the laser beam focus in an X-Y direction perpendicular to the main axis of the microscope objective. The laser microdissection device also includes at least one of a Z displacement device configured to move the microscope stage in a Z direction, or an optical focus shifting device configured to move the focus of the laser beam in the Z direction. The Z displacement device and/or optical focus shifting device are controllable, together with the optical laser scanning device, so as to move the laser beam focus in the specimen along a three-dimensional cut line in an X-Y-Z direction.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically shows the construction of a laser microdissection device according to an embodiment of the invention;

FIG. 2 schematically shows a microscope having a laser microdissection device according to the invention, together with the mechanism of the optical laser focus shifting device;

FIG. 3 schematically shows the microscope of FIG. 2 having a laser microdissection device according to the invention, together with the mechanism of the Z displacement device for the microscope stage; and

FIG. 4 shows various motion directions of the laser beam focus (FIG. 4A) as well as various cut lines (FIGS. 4B to 4D) that can be generated with the laser microdissection device according to the invention.

### DETAILED DESCRIPTION

It has been found that the microdissection of thick and/or aqueous specimens using known laser microdissection devices and methods often proves problematic. With thick samples, dissection using a laser beam cut line is often insufficient in the case of upright microscopes to detach the dissectate from the surroundings by the action of gravity, or in the case of inverted microscopes to prepare it suitably for the additional transfer steps necessary in that context (such as catapulting or fusing). Aqueous samples or those containing a great deal of water are problematic because the water defocuses the laser beam and thus necessitates high laser energies so that appropriate results can be achieved. A combination of thick and aqueous samples combines the aforementioned problems. Cutting with high laser energies can negatively influence surrounding sample regions (tissue). “Thick” samples are to be understood as those that are more than 30 μm thick, while “aqueous” samples are to be understood as those that are not dehydrated or those that are rehydrated (rehydration can also occur as a result of ambient atmospheric moisture when samples are used for a long time). Examples of aqueous samples are natural unfixed tissue sections, in particular for organotypic section cultures, cell cultures, or non-dehydrated prepared specimens.

An aspect of the present invention is therefore to describe a laser microdissection device and method that are capable of reliably dissecting in particular thick and/or aqueous specimens, in particular avoiding the aforementioned disadvantages. It is intended in particular that laser microdissection be capable of being performed on both upright and inverted microscopes.

The invention relates to a laser microdissection device having: a microscope stage for carrying a specimen to be cut, a laser light source for generating a laser beam, a microscope objective for focusing the laser beam onto the specimen, and having an optical laser scanning device for deflecting the laser beam in such a way that the laser beam focus is moved in an X-Y direction perpendicular to the main axis of the microscope objective (usually in the horizontal plane). In the context of this laser microdissection device, a Z displacement device for the microscope stage is provided in order to move the microscope stage in the Z direction, i.e. perpendicular to the aforesaid X-Y plane. Alternatively or additionally, an optical focus shifting device is present which moves the focus of the laser beam in the Z direction. The microscope stage displacement device and/or the laser focus shifting device are controllable, together with the optical laser scanning device, in such a way that the laser beam focus can be moved in the specimen along a three-dimensional cut line in an X-Y-Z direction. The subject of the invention is furthermore a corresponding method according to Claim 9. Advantageous embodiments are evident from the respective dependent claims and the description which follows.

The present invention makes it possible to dissect a specimen along an arbitrarily definable cut line in three-dimensional space. The cut line is, in particular, uninterrupted, i.e. continuous in the mathematical sense. It can be represented by a function in three-dimensional space, i.e. as a function of the X, Y, and Z coordinates. As mentioned earlier, in order to cut the sample the laser beam focus is moved along the cut line or the laser beam pulses are placed appropriately along the cut line. The corresponding deflection in the X and Y directions occurs by means of a known optical laser scanning device, for example a mirror scanner or a galvanometer scanner, but in particular a scanning device having rotatable wedge prisms or glass wedge plates.

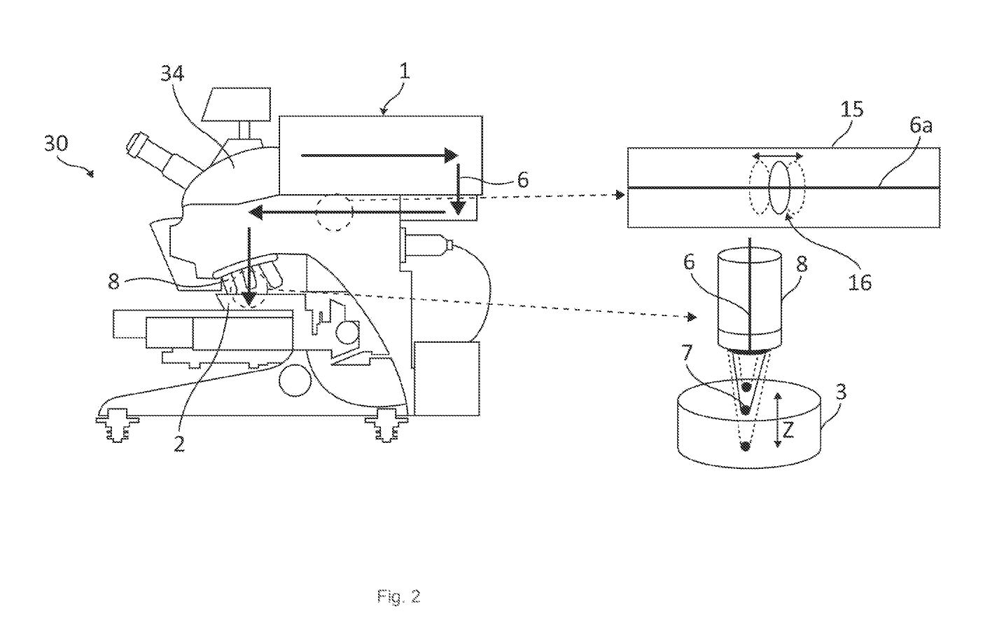

A particularly suitable laser scanning device having two thick glass wedge plates rotatable independently of one another around an axis is known from the previously discussed patent DE 100 18 253 C2. Here the glass wedge plates are designed, in particular, in such a way that the laser beam experiences at the exit from the laser scanning device, as a result of the thickness and the obliquity of the glass wedge plates, a lateral beam offset Δ with respect to the optical axis or the main axis of the microscope objective, the center of the objective pupil of the microscope objective being arrived at for all deflections of the beam path in the X-Y direction. The influence of the thickness and inclination (obliquity) of the glass wedge plates and of the wedge angle, correlated therewith, of each glass wedge plate on the beam offset Δ of the laser beam and on the angle α thereby defined, which is enclosed on the one hand by the laser beam and on the other hand by the optical axis (main axis) of the microscope objective, can be gathered from FIGS. 2a and 2b, along with the associated descriptive text, of the aforementioned patent DE 100 18 253 C2. To avoid repetition, reference is expressly made to the statements relative thereto in said document, which are assumed to be incorporated here for purposes of disclosure.

The motion in the Z direction necessary for guiding the laser beam focus along the three-dimensional cut line can be accomplished according to the present invention in three ways.

On the one hand, the specimen to be cut that is present on the microscope stage can be moved in the Z direction by means of a Z displacement device for the microscope stage. In this case the laser beam focused into the specimen consequently moves relative to the microscope stage and thus also relative to the specimen in the Z direction. A Z displacement device for the microscope stage, i.e. a motorized drive unit that shifts the microscope stage parallel to the main axis of the microscope objective, is known as such from the existing art.

Alternatively, the relative motion of the laser beam focus in the Z direction with respect to the microscope stage, and thus with respect to the specimen present thereon, can also be realized by means of an optical focus shifting device that moves the focus of the laser beam in the Z direction. An optical focus shifting device of this kind is arranged in particular in front of the microscope objective with reference to the laser beam propagation direction, and is made up of one or more lenses, at least one lens being mounted movably in the laser beam propagation direction. A shift of the relevant lens (which is also intended to include a lens group) brings about a shift of the laser beam focus in the Z direction, i.e. parallel to the main axis of the microscope objective through which the laser beam is being directed.

Lastly, the two aforesaid capabilities for shifting the laser beam focus in the Z direction relative to the microscope stage, i.e. a microscope stage displacement and a displacement by means of the optical focus shifting device, can also be used together, for example if shifting ranges of the one capability are exhausted so that the shifting range is expanded by the other capability, or if one of the two capabilities is more suitable for larger shifts while the other capability is more suitable for small shifts.

It is advantageous in particular if the microscope stage is arranged in stationary fashion with respect to the X-Y direction upon cutting. The reason is that this permits easy viewing of the specimen during the cutting operation via a camera, since the image of the received specimen does not move in the image acquisition plane of the camera. In addition, an expensive X-Y scanning stage is not necessary with this embodiment.

It is particularly useful if the microscope objective for focusing the laser beam onto the specimen is embodied simultaneously as a (conventional) microscope objective for an observation beam path proceeding from the specimen. In other words, the conventional microscope objective for imaging at least a portion of the specimen is simultaneously used to focus the laser beam for microdissection.

A UV laser, in particular a UVA laser, is used as a laser light source, since UVA radiation does not destroy RNA or DNA; this can be critical for genetic-engineering investigations. At the same time, a high level of laser energy can be made available in the UVA spectral region. Also suitable are IR or VIS lasers that emit in the infrared and the visible spectral region, respectively.

A so-called “UV offset” optic is present, for example, in laser microdissection devices that operate with a UV laser, in order to adapt the laser focus to the microscope focus that is in the visual spectral region. This offset optic can also be used for the present invention. For this purpose, the optic is used not for focus correction but instead to shift the laser focus in the Z direction.

It is advantageous if the laser beam guidance system is combined at least in part with an (incident-light) device for illuminating the specimen. An arrangement of this kind is known, for example, from DE 100 18 253 C2 and from DE 10 2005 008 925 A1, and reference is explicitly to be made in this regard to those documents.

The invention is not limited to utilization with upright microscopes, as is known once again from DE 100 18 253 C2, but instead is suitable in the same way for inverted microscopes such as those likewise known per se from the existing art.

The invention is outstandingly suitable for cutting thick and/or aqueous specimens. Thick specimens typically possess layer thicknesses to be cut that are greater than 30 μm. The invention is of course also usable for thinner specimens. Aqueous specimens are non-dehydrated or rehydrated specimens, as already discussed in the descriptive introduction. Aqueous specimens of this kind typically have water contents above 30%. According to the present invention, a three-dimensional cutting line can be placed through the relevant specimen. It is consequently no longer necessary to attempt to dissect the relevant specimen region with a single cut line along which the laser beam in some cases passes repeatedly. The disadvantages associated therewith have already been discussed above.

It is now possible to cut a dissectate of any desired contour out of the specimen. In a simple case, for example, a cylindrical dissectate can be cut out using a helical or spiral-shaped cut line having a specific pitch that is adapted to the specimen being cut. Conical dissectates, or those of any other shape, can also be generated using the invention. The only limitation on possible shapes is that the dissectate must be detached from its surroundings in order to be made available for subsequent investigations.

The invention further relates to a corresponding laser microdissection method for cutting a specimen along a cut line by means of a laser beam focused into the specimen, the specimen to be cut being carried by a microscope stage, the laser beam being focused into the specimen by means of a microscope objective, and the laser focus being moved by means of a laser scanning device in an X-Y direction perpendicular to the main axis of the microscope objective. By additional displacement of the microscope stage in the Z direction and/or by means of an additional optical focus shifting device that moves the focus of the laser beam in the Z direction, according to the present invention the laser beam focus can be moved along a three-dimensional cut line in an X-Y-Z direction.

Regarding details and embodiments of the method according to the present invention, reference is made expressly to the explanations above in conjunction with the laser microdissection device according to the present invention. These statement apply in the same manner to the method claimed, which will not be discussed again in detail.

Further advantages and embodiments of the invention are evident from the description and from the appended drawings.

It is understood that the features recited above and those yet to be explained below are usable not only in the respective combination indicated, but also in other combinations or in isolation, without departing from the scope of the present invention.

The invention is schematically depicted in the drawings on the basis of an exemplifying embodiment and will be described in detail below with reference to the drawings.

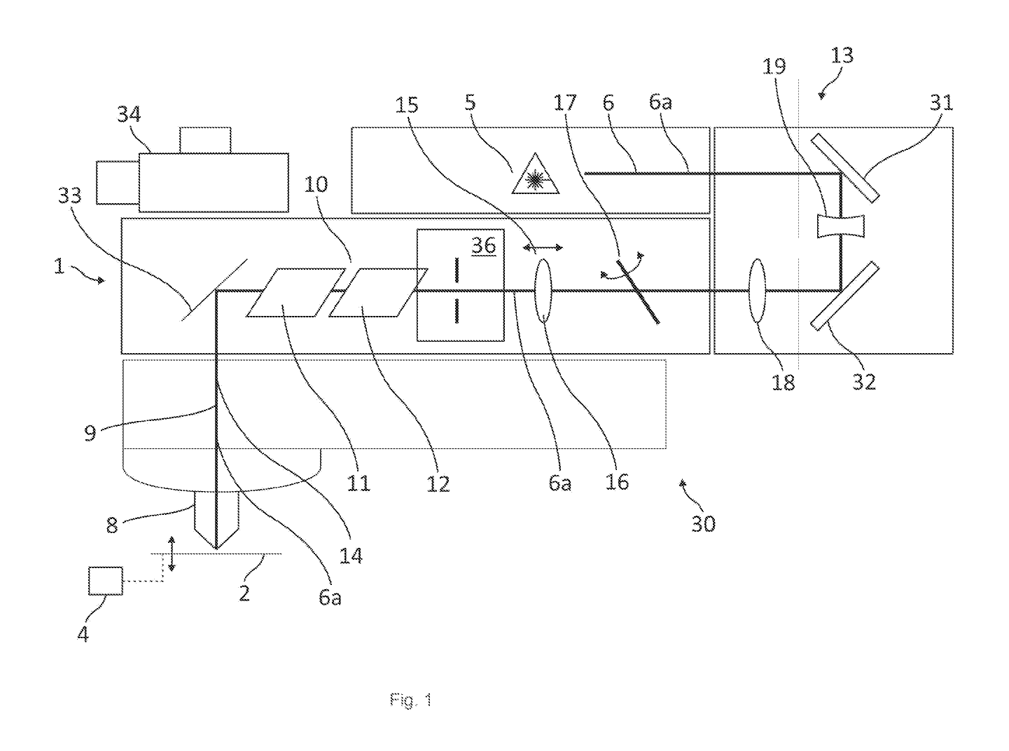

FIG. 1 shows a laser microdissection device 1 that is integrated into a microscope 30. The microscope stage is labeled 2, the microscope objective is labeled 8, and the tube is labeled 34. According to this exemplifying embodiment the elements of laser microdissection device 1 are as follows: laser light source 5 which generates a laser beam 6, deflection elements 31 and 32, and a negative lens 19 as well as a positive lens 18; a movable (double arrow) attenuator 17 for the laser beam, which is usually a filter that reduces the intensity as a function of the position of the filter; an optical laser focus shifting device 15 (to be discussed later), an aperture device 36, a laser scanning device 10, and a further deflection element 33. Also depicted is a Z displacement device 4 for microscope stage 2 in order to shift the latter in the Z direction (double arrow).

The main axis of microscope objective 8 is labeled 9. The Z direction extends parallel to main axis 9. The “X-Y direction” refers to a direction in a plane perpendicular to main axis 9, which plane is coincident here with the horizontal plane of microscope stage 2 of microscope 30. The laser beam propagation axis is labeled 6a. A laser deflection unit of laser microdissection device 1 is labeled 13. An illumination light source, as well as further elements of an illumination optic of an incident-light device, are not depicted. The illumination beam path (not depicted) of the laser microdissection device serves to illumination the specimen, imaged by microscope 30, on microscope stage 2. By way of corresponding interfaces on tube 34, the specimen can be observed directly visually and/or by a camera, in particular during the cutting operation.

Further details regarding laser microdissection device 1 depicted in FIG. 1 may be gathered from the Applicants German patent DE 100 18 253 C2 that has already been discussed in detail in the descriptive introduction. Contained therein, in particular, are detailed statements regarding the construction and the manner of operation of laser scanning device 10 depicted schematically in FIG. 1, which comprises two thick glass wedge plates 11 and 12 that are inclined in terms of optical axis 14 (which here coincides with laser beam propagation axis 6a) and are rotatable independently of one another around that axis. Laser beam 6 that is guided through these glass wedge plates 11 and 12 is deflected through a deflection angle α with respect to optical axis 14. This deflection angle can be adjusted or varied by rotating wedge plates 11 and/or 12. The thickness and the obliquity of glass wedge plates 11 and 12 is designed in such away that for all deflection angles a, the center of the objective pupil of microscope 8 is arrived at. A further advantage of this laser scanning device 10 is that an X-Y scanning stage does not need to be used as microscope stage 2, since the microscope stage can remain stationary during the cutting operation. This is because the motion of laser beam 6 that is focused through microscope objective 6 onto or into specimen 3 occurs in the X-Y direction exclusively by means of laser scanning device 10. Aperture device 36 suitably adjusts the laser beam aperture. The optical elements of laser microdissection device 1 that are depicted in FIG. 1 serve to make laser beam focus 7 available at the specimen with a suitable diameter and a suitable intensity that are particularly suitable for cutting the latter.

The schematically depicted optical focus shifting device 15 encompasses at least one lens 16 (which is also intended to include a lens element or lens group) that is shiftable in the direction of laser beam propagation axis 6a. The corresponding motion is indicated by the double arrow. A lens motion of this kind serves to move laser beam focus 7 (see FIG. 2) in the Z direction. A relative motion between laser beam focus 7 and specimen 3 or microscope stage 2 can also be achieved by Z displacement of microscope stage 2 by way of the corresponding Z displacement device 4.

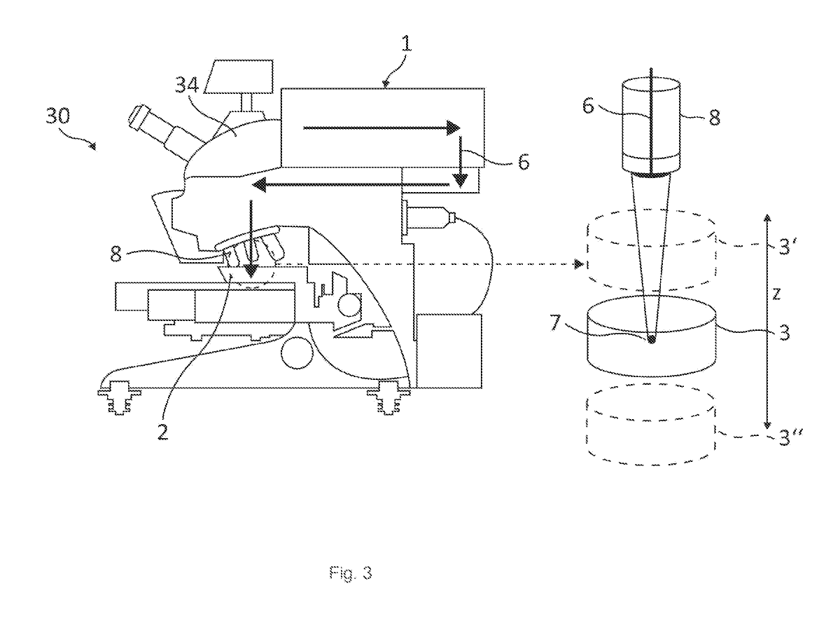

The capabilities just recited for relative shifting of laser beam focus 7 with reference to a specimen 3 mounted on microscope stage 2 are shown by FIGS. 2 and 3.

A microscope 30, whose essential beam path is depicted in FIG. 1 discussed above, is graphically depicted again on the left side of FIG. 2. Optical laser focus shifting device 15 is schematically depicted at enlarged scale on the right side of FIG. 2, along with microscope objective 8 and a portion of specimen 3 located therebeneath.

FIG. 2 shows a microscope 30 having a microscope stage 2, an objective 8, and a tube 34, elements that have already been reproduced schematically in FIG. 1. The eyepiece for visual viewing, as well as a camera monitor, are visible and are connected to tube 34. The laser microdissection device is labeled in its entirety as 1. The laser beam used to cut microdissectates out of a specimen 3 that is present on microscope stage 2 is again labeled 6. FIG. 2 serves merely to explain the capability of controlling laser focus shifting device 15 in such a way that laser beam focus 7 is moved in the Z direction.

Lens 16 present in optical focus shifting device 15 is mounted shiftably along laser beam propagation axis 6a. A shift can be performed in the direction of the double arrow. Focus 7 of laser beam 6 migrates in the Z direction (see double arrow in Z direction), i.e. in particular in the Z direction within specimen 3, depending on the shift. Only a cylindrical portion of the specimen is shown here. Specimen 3 is located on microscope stage 2.

By additional application of control to optical laser scanning device 10 (see FIG. 1), which moves laser beam focus 7 in defined fashion in the X-Y direction, it is possible, by controlling optical laser focus shifting device 15, to move laser focus 7 along a three-dimensional cut line in specimen 3 in an X-Y-Z direction. A three-dimensional cut line of this kind is, in particular, uninterrupted, i.e. continuous in the mathematical sense.

FIG. 3 shows a further possibility for Z motion of laser beam focus 7 inside specimen 3.

Reference is made for this purpose to the entirety of FIGS. 1 and 2 with the associated description. FIG. 3 schematically shows, on the right side, the manner of operation of Z displacement device 4 for microscope stage 2 (see FIG. 1).

For better comprehension, optical focus shifting device 15 of FIG. 2 is assumed to be deactivated or not present in FIG. 3. Specimen 3 is located on microscope stage 2. Microscope stage 2 is movable in the Z direction by means of a Z displacement device 4 (see FIG. 1). The possible shift range resulting therefrom is depicted (merely schematically) on the right side of FIG. 3. In the initial position, laser beam 6 focused by microscope objective 8 is assumed to travel into the interior of specimen 3, of which in turn only a cylindrical portion is shown. When microscope stage 2 is moved in the Z direction upward, it reaches a position in which the specimen is labeled 3′. When microscope stage 2 travels in the Z direction downward, it reaches a position in which the specimen is labeled 3″. In the two positions 3′ and 3″ that are shown, laser beam focus 7 is located outside specimen 3. In the context of smaller shift distances in the Z direction, laser beam focus 7 can consequently be shifted over the height of specimen 3 in the Z direction. Together with an application of control to optical laser scanning device 10 explained in conjunction with FIG. 1, it is thereby possible to generate a three-dimensional cut line in an X-Y-Z direction in specimen 3. This cut line is once again, in particular, uninterrupted, i.e. continuous.

Lastly, the two mechanisms from FIGS. 2 and 3 can be utilized together. Depending on the application instance and the optical configuration, one of the two Z shift capabilities can be respectively used for finer or coarser Z displacements. The two Z shifting capabilities can furthermore supplement one another, for example if the displacement range of the one capability is exhausted, so that the other capability can be employed in order to expand the displacement range.

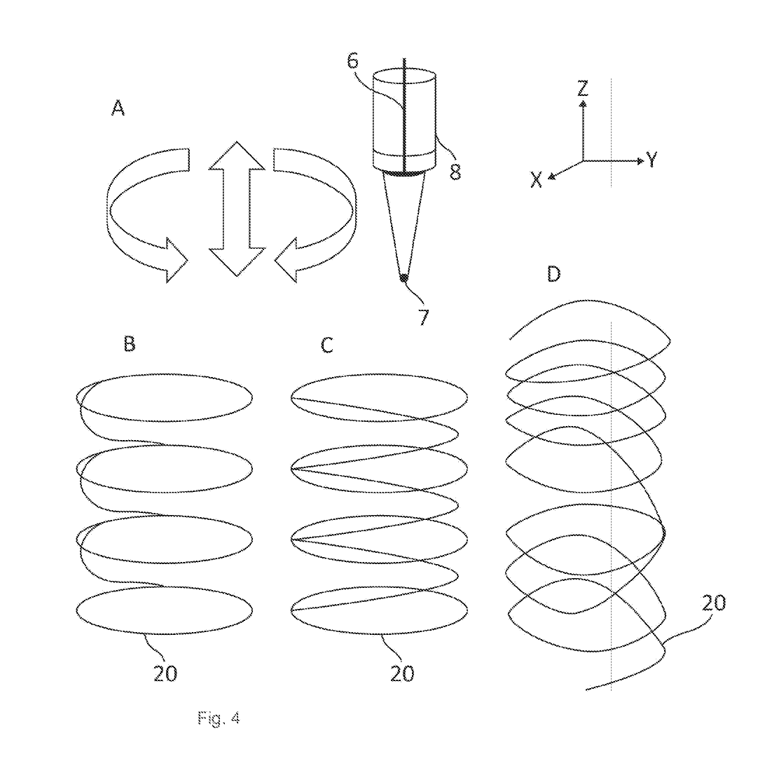

FIG. 4 shows, once again schematically, the three spatial directions X, Y, Z, microscope objective 8, laser beam 6 along with laser beam focus 7, and the possible motion directions of laser focus 7. In the preceding Figures the X-Y direction was identified with a direction in the horizontal plane of microscope stage 2, while the Z direction was identified with a direction perpendicular thereto that extends parallel to main axis 9 of microscope objective 8 (see FIG. 1). The three arrows in FIG. 4A designate possible motion directions of laser beam focus 7 in three-dimensional space: the two curved arrows schematically illustrate motions in an X-Y direction, while the double arrow denotes motions in a Z direction. Cut lines 20 that are depicted in FIGS. 4B to 4D can be generated from these motion directions. Cut lines 20 depicted here serve in particular for the dissection of tubes or cylindrical segments out of a specimen. The tissue here is, in particular, thick, where “thick” means the dimension in the Z direction. Cut lines 20 are suitable in particular for dimensions greater than 30 μm.

In FIG. 4B, the cut line describes a respective circle in the X-Y direction at different Z coordinates, the individual circles being connected to one another by modifying the Z coordinates. Laser focus 7 cuts actively while the entire cut line 20 is being traveled. In FIG. 4B the change of plane in the Z direction occurs with approximately a quarter-circle rotation to the next plane. FIG. 4C shows a similar cut line, except that here the change in plane occurs with a complete helical motion.

If only helical motions are used, what results is a cut line 20 depicted in FIG. 4D. The slope of cut line 20 is freely selectable in FIG. 4D, and also variable throughout the motion.

In principle, a cut line 20 having any geometry in three-dimensional space can be generated. Cones, ellipsoids, squares, and combinations of such basic figures are, for example, possible.

The cut lines depicted in FIGS. 4B to 4D are suitable in particular for dissecting cylindrical segments out of thick and/or aqueous specimens 3. Microdissection can be carried out in particular using a comparatively low laser energy. The energy should be dimensioned such that the cohesion of the specimen in the Z direction along cut line 20 is so low that it is possible to detach the dissectate from the surrounding sample or for it to fall out in response to gravity.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

### LIST OF REFERENCE NUMERALS

1 Laser microdissection device

2 Microscope stage

3, 3′, 3″ Specimen

4 Z displacement direction

5 Laser light source

6 Laser beam

6a Laser beam propagation axis

7 Laser beam focus

8 Microscope objective

9 Main axis of microscope objective

10 Laser scanning device

11 Glass wedge plate

12 Glass wedge plate

13 Laser deflection unit

14 Optical axis

15 Optical focus shifting device

16 Lens

17 Attenuator

18 Lens

19 Lens

20 Cut line

30 Microscope stage

31 Deflection element

32 Deflection element

33 Deflection element

34 Tube

36 Aperture device

What is claimed is:

1. A laser microdissection device comprising:
a microscope stage for carrying a specimen to be cut;
a laser light source for generating a laser beam;
a microscope objective for focusing the laser beam onto the specimen, the microscope objective having a main axis;
an optical laser scanning device for deflecting the laser beam so as to move the laser beam focus in an X-Y direction perpendicular to the main axis of the microscope objective; and
at least one of
a Z displacement device associated with the microscope stage that is configured to move the microscope stage in a Z direction, or
an optical focus shifting device configured to move the focus of the laser beam in the Z direction,
wherein the at least one of the Z displacement device and the optical focus shifting device are controllable, together with the optical laser scanning device, so as to move the laser beam focus in the specimen along a three-dimensional cut line in an X-Y-Z direction.

2. The laser microdissection device as recited in claim 1, wherein the optical laser scanning device comprises two glass wedge plates inclined in terms of a laser propagation axis and rotatable independently of one another around the axis.

3. The laser microdissection device as recited in claim 2, wherein the glass wedge plates are designed so as to provide an exit for the laser beam from the laser scanning device, as a result of the thickness and the obliquity of the glass wedge plates, a lateral beam offset with respect to the main axis of the microscope objective, the center of the objective pupil of the microscope objective being arrived at for all deflections of the laser beam.

4. The laser microdissection device as recited in claim 1, wherein the microscope stage is arranged in stationary fashion with respect to the X-Y direction upon cutting.

5. The laser microdissection device as recited in claim 1, wherein the microscope objective for focusing the laser beam onto the specimen is embodied simultaneously as a microscope objective for an observation beam path proceeding from the specimen.

6. The laser microdissection device as recited in claim 1, wherein the optical laser focus shifting device comprises at least one lens that is shiftable in a direction of a propagation axis of the laser beam.

7. The laser microdissection device as recited in claim 1, wherein the laser light source is a UV, IR, or VIS laser.

8. The laser microdissection device as recited in claim 1, wherein the microscope objective and the microscope stage are constituents of an inverted or an upright microscope.

9. The laser microdissection device as recited in claim 1, wherein the specimen to be cut is at least one of a thick or an aqueous specimen.

10. A laser microdissection method for cutting a specimen along a cut line using a laser beam focused into the specimen, the method comprising:
providing the specimen to be cut on a microscope stage;
focusing the laser beam into the specimen using a microscope objective;
moving the laser beam focus using a laser scanning device in an X-Y direction perpendicular to a main axis of the microscope objective; and
moving the laser beam focus along a three-dimensional cut line in an X-Y-Z direction by at least one of displacing the microscope stage in a Z direction or moving a focus of the laser beam in the Z direction using an optical focus shifting device.

11. The laser microdissection method as recited in claim 10, wherein the microscope stage is arranged in stationary fashion with respect to the X-Y direction upon cutting.

12. The laser microdissection method as recited in claim 10, wherein the optical laser focus shifting device comprises at least one lens, shiftable in a direction of a laser beam propagation axis, that is shifted in the direction of a propagation axis of the laser beam in order to move the laser beam focus in the Z direction.
